(19) United States
(12) Patent Application Publication
(10) Pub. No.: US 2008/0041519 A1
(43) Pub. Date: Feb. 21, 2008

(54) METHOD OF PRODUCING VACUUM PACKAGING FILM HAVING AIR CHANNEL AND METHOD OF PRODUCING VACUUM PACKAGING BAG USING THE FILM

(75) Inventor: Jong Seouk Lee, Suheung-si (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LOCK & LOCK CO., LTD., Asan (KR)

(21) Appl. No.: 11/840,634

(22) Filed: Aug. 17, 2007

(30) Foreign Application Priority Data
Aug. 21, 2006 (KR) 10-2006-0079006

(51) Int. Cl. B32B 38/04

(52) U.S. Cl. 156/259

(57) ABSTRACT

A method of producing a vacuum packaging film that has one or more air channels includes longitudinally cutting a sheet to form one or more channels by using a plurality of ring knives that are arranged at intervals from each other. A border sheet is provided while an exhaustion sheet is removed. The border sheet is layered on a side of a supply film. The border sheet and the supply film are provided to a layering roller. The border sheet and the supply film are laminated by using the layering roller to form a border part of the air channel.

### BACKGROUND OF THE INVENTION

1. Field of the Invention

The present invention relates to a method of producing a vacuum packaging film and, in particular, to a method of producing a vacuum packaging film having an air channel, in which a sheet for forming the channel is longitudinally cut by using a twin ring knife or a ring knife, or a wire, a string, a belt, or a net for forming the channel is provided. Also, the present invention relates to a method of producing a vacuum packaging bag using the film produced by the above-mentioned method.

2. Description of the Related Art

In a known technology where an air channel is formed in a vacuum packaging film, a typical vacuum packaging film is pressed by using an embossed hot roller to form the air channel. The technology is problematic in that since the air channel is formed by pressing the film using the embossed hot roller, pin holes are frequently formed, generating many defects. In addition, the production cost becomes increased if using an embossed roller and changing the shape of the embossed pattern. Further, since the air channel is formed by using the embossed roller while polyethylene is melt-extruded, the height of the air channel is not uniform. Additionally, since a film for forming an air channel is layered on the vacuum packaging film in order to form the air channel, the production cost is increased. In the case where the film for forming the air channel is to be colored, the entire surface of the vacuum packaging film, not only a pattern thereof, is colored.

Korean Registered Patent No. 0444402 discloses a process that includes providing a heat-sealable resin that is subjected to melt extruding to a cooling roller and a layering roller to form a plurality of protrusions by using a plurality of grooves each having a predetermined pattern on a circumferential surface of the cooling roller and to form channels corresponding to the intervals between the protrusions. However, in the case where the channels are formed by using the above-mentioned method, since the grooves are formed on the cooling roller, it is difficult to easily control the height of each of the channels and it is necessary to replace the cooling roller in order to change the height or shape of each of the channels, thereby increasing cost.

Korean Registered Utility Model No. 0248033 discloses a vacuum packaging bag that longitudinally extends in respects to tube elements and includes an inner layer having the tube elements defining channels which protrudes from at least one inner side of the bag and through which air is exhausted from the bag by suction when the vacuum packaging bag is used. However, the above-mentioned utility model discloses a tube member for forming the vacuum packaging bag, not a method of producing the tube member. Furthermore, in the case where the film of the utility model is used, there is a problem in that it is difficult to control the height of the thin and long member.

### SUMMARY OF THE INVENTION

An object of the present invention is to control the thickness of a sheet for forming a channel so as to easily adjust the height of the air channel.

It is a first object of the present invention to provide a method of improving the quality of products which includes laminating a typical vacuum packaging film and a sheet for forming a channel having a predetermined height to maintain the height of the channel such that the vacuum packaging film is not damaged without pin holes.

It is a second object of the present invention to provide a method of performing selective lamination of a film where a channel is formed on a portion of the vacuum packaging film to reduce production cost.

It is a third object of the present invention to provide a method of forming channels having various shapes in a short period of time at low cost by using a simple channel production device.

It is a fourth object of the present invention to provide a method of cutting a sheet for forming a channel having a predetermined color or performing lamination of a wire, a string, a belt, or a net having a predetermined color and a first supply film to provide an aesthetic vacuum packaging film and allow a portion of a vacuum packaging bag to have a predetermined color.

A first aspect of the present invention provides a method of producing a vacuum packaging film that has an air channel, said method comprising longitudinally cutting a sheet for forming a channel by using a plurality of twin ring knives that are arranged at regular intervals in respects to a width of the sheet, and providing a border sheet while an exhaustion sheet is outputted; layering the border sheet on a side of a first supply film and providing the border sheet and the first supply film to a layering roller including a cold roller and a hot roller; and laminating the border sheet and the first supply film by using the layering roller to form a border part of the air channel. The first supply film is plastic or polymer in one implementation, but may be of other materials in other implementations.

A second aspect of the present invention provides a method of producing a vacuum packaging film that has an air channel, said method comprising longitudinally cutting a sheet for forming a channel by using a plurality of ring knives that are arranged at regular intervals in respects to a width of the sheet to provide a border sheet; layering the border sheet on a first supply film and providing the border sheet and the first supply film to a layering roller including a cold roller and a hot roller; and performing lamination of the first supply film on which the border sheet is layered by using the layering roller to form a border part of the air channel.

A third aspect of the present invention provides a method of producing a vacuum packaging film that has an air channel, said method comprising layering wires, strings, belts, or nets for forming the channel that are arranged at regular intervals on a first supply film and providing the wires, the strings, the belts, or the nets and the first supply film to a layering roller including a cold roller and a hot roller; and performing lamination of the first supply film on which the wires, strings, belts, or nets for forming the channel are layered by using the layering roller.

Furthermore, a fourth aspect of the present invention provides a method of producing a vacuum packaging bag that has an air channel, said method comprising layering a first supply film and a second supply film; and tightly attaching corresponding left, right, and lower edges of the first and the second supply films to each other. At least one of the first and the second supply films is a vacuum packaging film having an air channel produced by using the method according to embodiments of the present invention.

A vacuum packaging film and the vacuum packaging bag that are made based on the above embodiments may have one or more of the following advantages. The vacuum packaging film is less likely to be damaged and the height of the air channel is maintained without pin holes. If necessary, the sheet for forming the channel is laminated with a portion of the vacuum packaging film, thus reducing production cost. Since a predetermined color can be provided to only the channel, it is possible to produce a aesthetic vacuum packaging bag.

### BRIEF DESCRIPTION OF THE DRAWINGS

FIG. 1 schematically illustrates a process of producing a vacuum packaging film that has an air channel formed by cutting a sheet for forming an air channel by means of a twin ring knife according to the present invention;

FIG. 2 schematically illustrates a process of producing a vacuum packaging film formed by cutting a sheet for forming an air channel by means of a twin ring knife path which has an “S” shape on a roller;

FIG. 3 schematically illustrates a process of producing a vacuum packaging film formed by cutting a sheet for forming an air channel by means of a twin ring knife path which has a “Z”-shape;

FIG. 4 schematically illustrates a process of producing a vacuum packaging film formed by cutting a sheet for forming an air channel by means of a twin ring knife path which has a “S”-shape;

FIGS. 5A and 5B illustrate rotation loci of the twin ring knives of FIGS. 3 and 4, in which FIG. 5A illustrates the “Z”-shaped pattern and FIG. 5B illustrates the “S”-shaped pattern;

FIG. 6 schematically illustrates a process of producing a vacuum packaging film that has an air channel formed by cutting a sheet for forming an air channel by means of a ring knife according to the present invention;

FIG. 7 illustrates a vacuum packaging film where an exhaustion sheet is layered on a border sheet by using the processes of FIGS. 1 and 6; and

FIG. 8 schematically illustrates a process of producing a vacuum packaging film that has a channel formed by using a wire, a string, a belt, or a net according to the present invention.

### DESCRIPTION OF THE PREFERRED EMBODIMENTS

Hereinafter, the present invention will be described in detail with reference to the drawings.

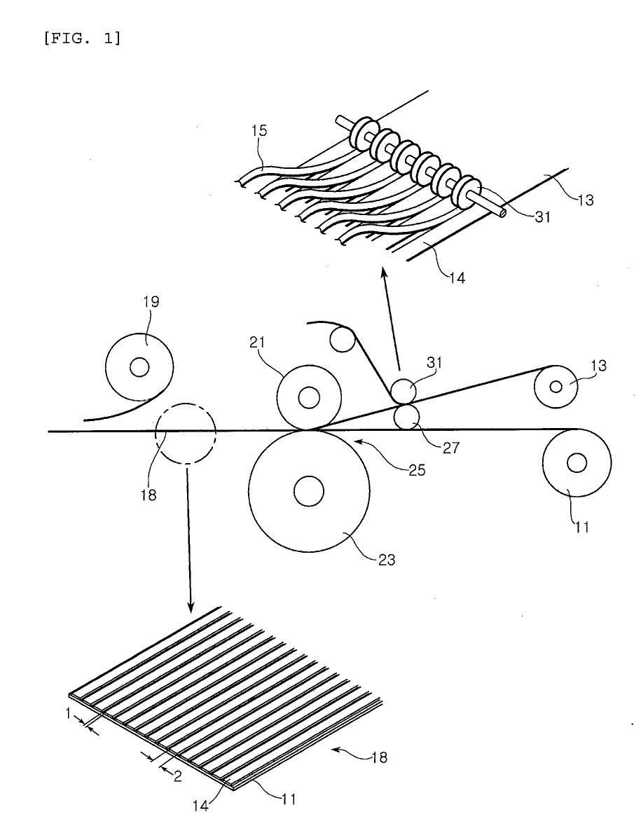

FIG. 1 schematically illustrates a process of producing a vacuum packaging film that has an air channel formed by cutting a sheet for forming an air channel by means of a twin ring knife according to a first embodiment.

According to the first embodiment of the present invention, as shown in FIG. 1, the method of producing the vacuum packaging film that has an air channel comprises longitudinally cutting a sheet 13 for forming a channel by using a plurality of twin ring knives 31 that are arranged at regular intervals in respects to the width of the sheet, and providing a border sheet 14 while an exhaustion sheet 15 is outputted.

Any twin ring knife 31 may be used as long as the twin ring knife includes a pair of ring-shaped knife blades. The twin ring knives are arranged at regular intervals in respects to the width of the sheet 13 for forming the channel to longitudinally cut the sheet 13 for forming the channel.

As to the plurality of twin ring knives 31, the interval between the knives and the interval between the twin ring knives are not limited, but may be appropriately controlled by those who skilled in the art to which the present invention belongs in consideration of formation of an air channel 1 and an air channel border part 2. Preferably, the channel border part 2 is 0.2 to 1 mm wide.

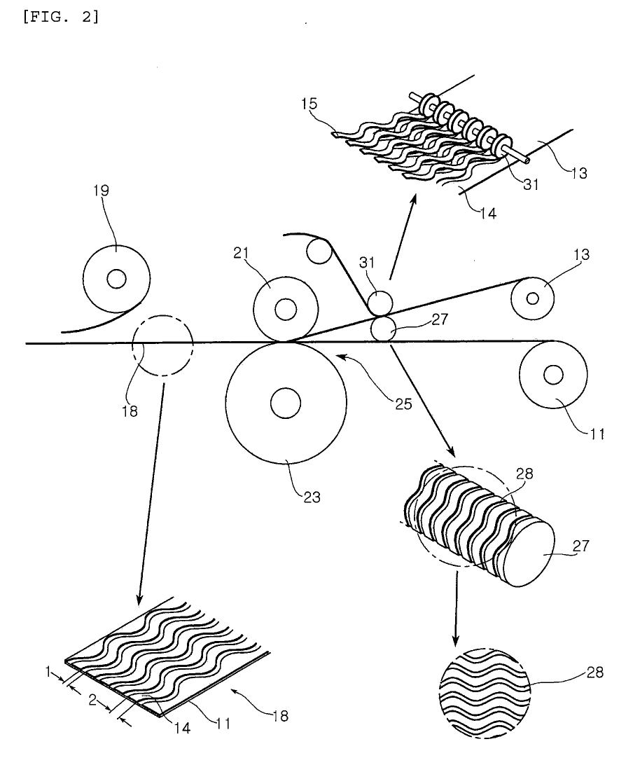

A roller 27 may be disposed under the twin ring knives 31. The roller 27 is used to safely provide the sheet 13 for forming the channel to the twin ring knives 31. Paths 28 through the twin ring knives 31 are capable of moving may be formed on the surface of the roller 27 by using insculping. FIG. 2 schematically illustrates a process of producing the vacuum packaging film 18 formed by cutting the sheet 13 for forming the air channels by means of the twin ring knife paths 28 which each have an “S” shape on the roller 27. It is preferable that the radius of curvature of each of the paths 28 be not very small so as to easily move the twin ring knives 31. The paths 28 may have various types of shapes. For example, each of the paths 28 may have a straight line shape or an “S” shape. The roller 27 on which the rotation paths 2B of the twin ring knives 31 are formed is provided so that the sheet 13 for forming the channel is cut to have the same shape as each of the paths of the roller 27 by using the twin ring knives 31. Thereby, the vacuum packaging film 18 where the channel 1 having a desired shape is formed is produced.

The type of the material of the roller 27 that is disposed under the twin ring knives 31 is not limited, but it is preferable that the roller 27 be made of low-priced material such as wood, rubber, plastic, and the like in consideration of reduction in cost. The roller functions to guide the paths 28 of the twin ring knives 31, and the cutting can be achieved even though the blade of the knife does not come into contact with the surface of the roller 27. Furthermore, the roller provides predetermined tension to the sheet 13 for forming the channel so as to easily cut the sheet by using the twin ring knives 31.

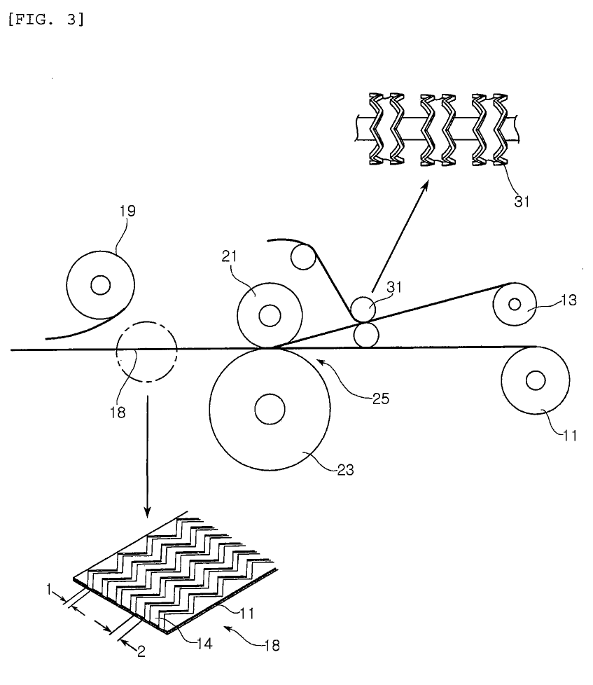

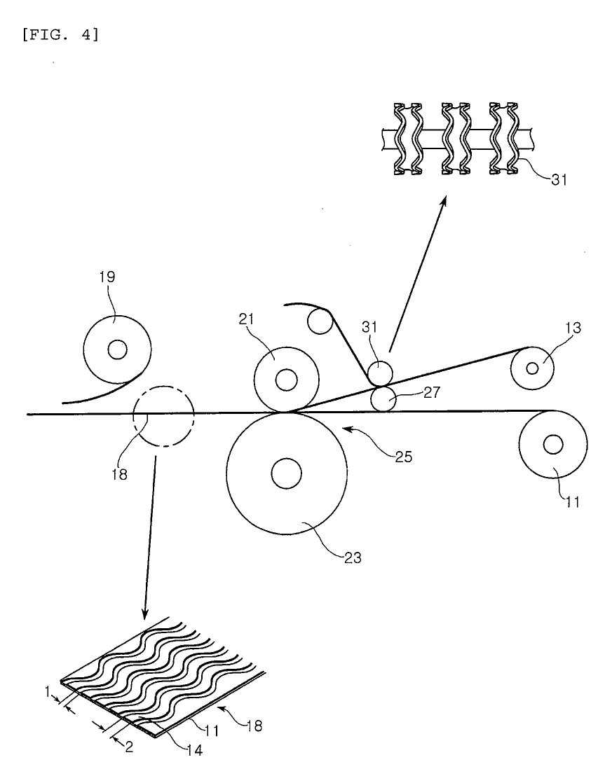

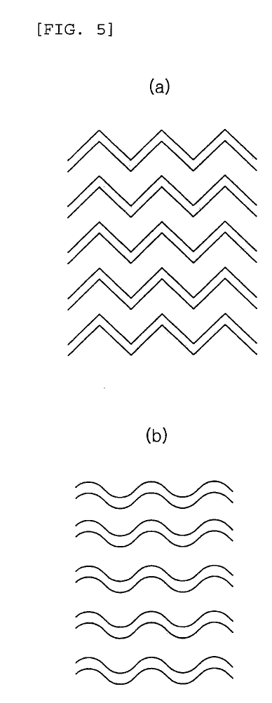

In addition, FIGS. 3 and 4 schematically illustrate processes of producing the vacuum packaging films 18 formed by cutting the sheets 13 for forming the air channel by means of the twin ring knives 31 which have a “Z”-shape and a “S”-shape according to an embodiment, and FIGS. 5A and 5B illustrates rotation loci of the twin ring knives 31 of FIGS. 3 and 4. As shown in FIGS. 3 to 5, the twin ring knife 31 may be formed to have the straight line shape, the “Z”-shape, or the “S”-shape. In this case, it is unnecessary to provide the roller 27 under the twin ring knives 31, or the paths 28 may be removed from the surface of the roller. Since each of the twin ring knives 31 has the above-mentioned shape, the sheet 13 for forming the channel is cut to have the same pattern as the shape of the twin ring knife 31. Thereby, it is possible to form the channel 1 having a desired shape.

Before the sheet 13 for forming the channel is provided to a layering roller 25 that includes the cold roller 21 and the hot roller 23, the sheet is longitudinally cut by using the twin ring knife 31 so as to form a strip. In the present invention, the sheet having the strip shape that is cut to correspond to the interval between the pairs of the twin ring knives 31 after the sheet comes into contact with a plurality of twin ring knives 31 refers to a “border sheet 14”, and the sheet that is cut to have the strip shape and correspond to the interval between the knives refers to an “exhaustion sheet 15”.

The sheet 13 for forming the channel is divided into the border sheet 14 and the exhaustion sheet 15 by using the twin ring knives 31. The exhaustion sheet 15 is removed or reused, and the border sheet 14 is layered on a first supply film 11 as described below and then laminated at a layering roller 25.

The border sheet 14 and the first supply film 11 are provided to the layering roller 25 that includes the cold roller 21 and the hot roller 23. The border sheet 14 is layered on the first supply film 11 to be provided to the layering roller 25, and the first supply film 11 on which the border sheet 14 is layered is heated and pressed by using the layering roller 25 to laminate the border sheet 14 on the first supply film 11. Thus, the air channel 1 that corresponds to the interval between the adjacent border sheets 14 is formed to produce the vacuum packaging film having the air channel.

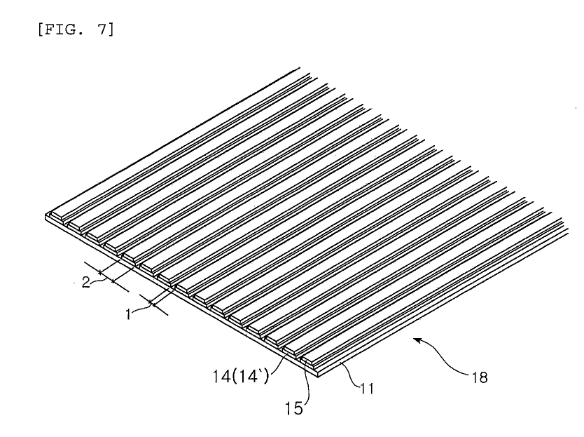

The exhaustion sheet 15 may be additionally layered on the border sheet 14 to increase the height of the border part of the air channel 1. The exhaustion sheet 15 may be layered on the border sheet 14 that is formed on the first supply film 11 after passing through the layering roller 25 and then pass through a second layering roller (not shown) that is disposed after the layering roller 25 to increase the height of the border part of the air channel 1. A vacuum packaging film 18 in which a plurality of air channel border part layers 2 is formed is shown in FIG. 7.

According to a second embodiment of the present invention, the sheet 13 for forming the channel is longitudinally cut by using a plurality of ring knives 33 that are arranged at regular intervals in respects to the width of the sheet to provide border sheets 14′, thereby producing the vacuum packaging film 18 having the air channel 1.

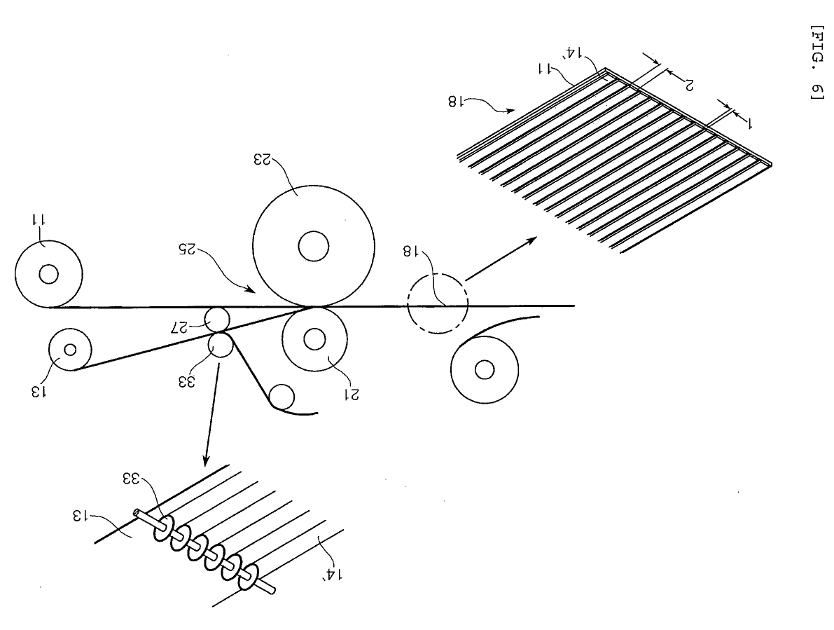

FIG. 6 schematically illustrates a process of producing the vacuum packaging film 18 that has the channel formed by cutting the sheet 13 for forming the channel by means of the ring knife 33.

As shown in FIG. 6, the ring knives 33 are arranged at regular intervals in respects to the width of the sheet and longitudinally cut the sheet 13 for forming the channel. The sheet 13 for forming the channel is cut by using the ring knives 33 to produce strips. Predetermined tension may be provided to the sheet 13 for forming the channel to easily cut the sheet by using the ring knives 33.

The roller 27 may be provided under the ring knives 33, and a straight line pattern or an “S”-shaped pattern may be formed on the surface of the roller 25 by using insculping to form the rotation paths of the ring knives 33. Thereby, it is possible to provide the border sheet 14′ that has the same pattern as the roller 27.

The ring knives may have various shapes to ensure various types of channels. That is, each of the ring knives 33 may be produced to have a straight line shape, a zigzag shape, or an “S”-shape.

When each of the ring knives 33 has the above-mentioned shape, the border sheet 14′ is cut by using the ring knives 33 to have the same pattern as the shape of each of the ring knives 33. Thereby, it is possible to provide an air channel 1 having a desired pattern to the vacuum packaging film 18.

The border sheets 14′ that are produced by using the sheet 13 for forming the channel and each have a strip shape is layered on the first supply film 11 and then provided to the layering roller 25. In this connection, the border sheets 14′ are rearranged at regular intervals so as to form the air channels 1 and then layered on the first supply film 11. Accordingly, it is preferable that the width of the sheet 13 for forming the channel be slightly smaller than that of the first supply film 11.

The first supply film 11 on which the border sheet 14′ is layered is provided to the layering roller 25 that includes the cold roller 21 and the hot roller 23. The first supply film 11 on which the border sheet 14′ is layered is heated and pressed by using the layering roller. 25 to produce the vacuum packaging film 18 having the air channel 1.

A second border sheet 15 may be layered on the border sheet 14′ where the air channels 1 are formed on the first supply film 11 (see FIG. 5). That is, a second ring knife is disposed after the layering roller 25 to cut another sheet 13 for forming the channel, thus forming the second border sheet 15. Next, the cut sheet is layered on the border sheet 14′ of the vacuum packaging film 18 on which the air channels 1 are formed and laminated with the second border sheet 15 by using a second layering roller (not shown) that is disposed after the second ring knife. In this connection, the second border sheet 15 that is layered on the border sheet 14′ must have the width that is smaller than that of the border sheet 14′. The border part may be formed between the channels to include two layers to increase the height of the air channel border part 2 (see FIG. 7).

In order to increase the height of the channel border part 2, positions of the ring knife 33, the twin ring knife 31, and the sheet 13 for forming the channel may be controlled to perform layering of two or more layers. A vacuum packaging film 18 that includes the channel border part 2 where two or more layers are layered is shown in FIG. 7.

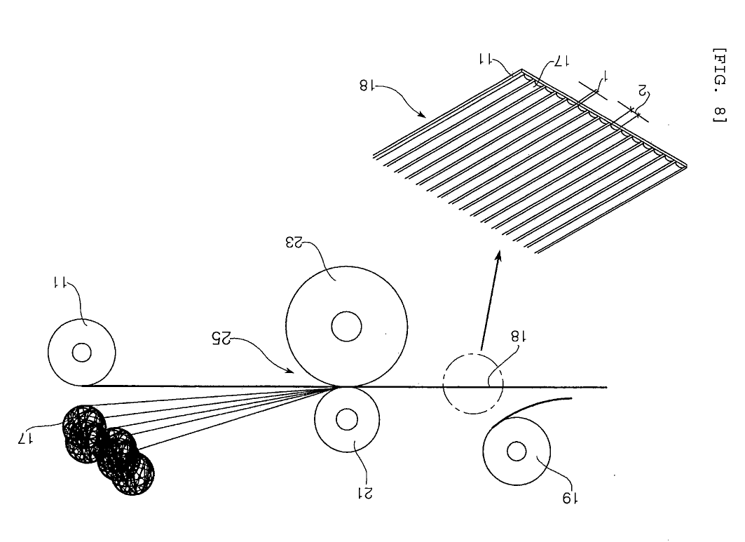

According to a third embodiment of the present invention, the method of producing the vacuum packaging film that has an air channel comprises layering a wire, a string, a belt, or a net 17 used to form the channels arranged at regular intervals on the first supply film 11 to provide the layered structure to the layering roller 25 that includes the cold roller 21 and the hot roller 23. FIG. 8 schematically illustrates a process of producing the vacuum packaging film 18 that has the channel 1 formed by using the wire, the string, the belt, or the net 17.

The width or thickness and the arrangement interval of the wire, the string, the belt, or the net 17 used to form the channel are not limited, but may be controlled so as to desirably form the air channel 1 of the vacuum packaging film 18.

The wires, the strings, the belts, or the nets 17 used to form the channel are arranged on the first supply film 11 at regular intervals to be provided to the layering roller 25 that includes the cold roller 21 and the hot roller 23.

The first supply film 11 on which the wires, the strings, the belts, or the nets 17 used to form the channel are layered is subjected to lamination by using the layering roller 25. Accordingly, the air channels 1 are formed by using the wires, the strings, the belts, or the nets 17 used to form the channel, thereby producing the vacuum packaging film 18.

In this connection, the thickness of the wire, the string, the belt, or the net 17 used to form the channel may be controlled to increase the height of the air channel border part 2.

In addition, the material constituting the first and the second supply films 11 and 19 is not limited as long as the material is impermeable to air like the material that is typically used to produce the vacuum packaging film 18 in the art to which the present invention belongs. Preferably, the film that includes two layers consisting of nylon and polyethylene is used, and an outer surface of a vacuum packaging bag is made of a resin that is impermeable to air, for example, nylon, in respects to production of the vacuum packaging bag.

Preferably, the above-mentioned sheet 13 for forming the air channel is laminated on the polyethylene side, and the border sheets 14, 14′, and 15 that are cut to a predetermined size by using the ring knives 33 or the wire, the string, the belt, or the net 17 that is used to form the channel are attached to the polyethylene sides of the first and the second supply films as the sheet 13 for forming the channel.

The material of the sheet 13 for forming the channel that is used in the present invention is not limited as long as the material is typically used to form the channels 1 in the art to which the present invention belongs. However, it is more preferable to use polyethylene.

The sheet 13 for forming the channel, the wire, the string, the belt, or the net 17 that is used in the present invention may have a predetermined color. The sheet 13 for forming the channel that has a predetermined color may be cut by using the ring knives 31 and 33 or the like to form the air channel 1. Thereby, the air channel 1 may have the color and a aesthetic vacuum packaging film 18 that could not obtained by using a known technology can be produced.

A second supply paper 19 may be provided to the vacuum packaging film 18 having the air channel 1 that is produced according to the embodiments of the present invention to produce a vacuum packaging bag (not shown).

The method of producing the vacuum packaging bag includes providing the second supply film 19 on the vacuum packaging film 18 where the air channels 1 are formed on the first supply film 11; and attaching left and right edges and lower edges of the vacuum packaging film 18 and the second supply film 19 to each other.

In this connection, the vacuum packaging film 18 that has the air channels 1 produced by using the above-mentioned method of the present invention may be used as the above-mentioned second supply film 19.

The vacuum packaging film that has the channel produced by using the method of the present invention is advantageous in that since the sheet for forming the channel having a predetermined height is laminated with a typical vacuum packaging film, the vacuum packaging film is not damaged and the height of the channel is maintained without pin holes, thereby improving the quality of products. In addition, since the film for forming the channel is selectively laminated with a portion of the vacuum packaging film for forming the air channel, production cost is reduced. In the case where the channel having a different shape is to be produced, the used ring knife is replaced with another type of ring knife, thus significantly reducing production time and production cost and simplifying the structure of equipment. Furthermore, since the sheet for forming the channel has a predetermined color, when the sheet is laminated with the vacuum packaging film, the vacuum packaging bag has a colored portion, and it is possible to produce a aesthetic vacuum packaging film. Additionally, it is possible to produce a low-priced vacuum packaging bag by using the vacuum packaging film of the present invention.

What is claimed is:

1. A method of producing a vacuum packaging film that has an air channel, the method comprising:
longitudinally cutting a sheet to form a channel by using a plurality of twin ring knives that are arranged at regular intervals in respects to a width of the sheet, and providing a border sheet while an exhaustion sheet is removed;
layering the border sheet on a side of a first supply film and providing the border sheet and the first supply film to a layering roller including a cold roller and a hot roller; and
laminating the border sheet and the first supply film by using the layering roller to form a border part of the air channel.

2. The method of producing a vacuum packaging film that has an air channel according to claim 1, further comprising:
layering the removed exhaustion sheet on the border sheet that is laminated on the first supply film to form the channel, and providing the exhaustion sheet and the border sheet to a second layering roller including a cold roller and a hot roller; and
laminating the first supply film where the exhaustion sheet is layered to form the channel and the second layering roller to increase a height of the border part of the air channel.

3. The method of producing a vacuum packaging film that has an air channel according to claim 2, wherein each of the ring knives has a straight line shape, or a “Z” or “S” shape, wherein each twin ring knife has twin blades.

4. The method of producing a vacuum packaging film that has an air channel according to claim 2, wherein a roller is provided under the ring knives so that continuous patterns each having a predetermined shape are insculped on a circumferential surface of the roller, and the ring knives are guided along the insculped patterns.

5. The method of producing a vacuum packaging film that has an air channel according to claim 1, wherein a roller is provided under the ring knives so that continuous patterns each having a predetermined shape are insculped on a circumferential surface of the roller, and the ring knives are guided along the insculped patterns.

6. The method of producing a vacuum packaging film that has an air channel according to claim 1, wherein each of the ring knives has a straight line shape, or a “Z” or “S” shape, wherein each twin ring knife has twin blades.

7. The method of producing a vacuum packaging film that has an air channel according to claim 1, wherein the sheet for forming the channel has a predetermined color.

8. The method of claim 1, wherein the first supply film is a thin-layered material.

9. A method of producing a vacuum packaging film that has an air channel, the method comprising:
longitudinally cutting a sheet to form a channel by using a plurality of ring knives that are arranged at regular intervals in respects to a width of the sheet to provide a border sheet;
layering the border sheet on a first supply film and providing the border sheet and a first supply film to a layering roller including a cold roller and a hot roller; and
performing lamination of the first supply film on which the border sheet is layered by using the layering roller to form a border part of the air channel.

10. The method of producing a vacuum packaging film that has an air channel according to claim 9, further comprising:
longitudinally cutting a sheet to form a second channel by using second ring knives that are arranged at denser intervals in comparison with the intervals between the above ring knives to provide a second border sheet;
layering the second border sheet on the border sheet that is laminated on the first supply film to form the channel and providing the second border sheet and the border sheet to a second layering roller including a cold roller and a hot roller; and
performing lamination of the first supply film on which the second border sheet is layered to form the channel by using the second layering roller to form the border part of the air channel.

11. The method of producing a vacuum packaging film that has an air channel according to claim 10, wherein the sheet for forming the channel has a predetermined color.

12. A method of producing a vacuum packaging film that has an air channel, the method comprising:
layering wires, strings, belts, or nets for forming the channel that are arranged at given intervals on a first supply film and providing the wires, the strings, the belts, or the nets and the first supply film to a layering roller including a cold roller and a hot roller; and
performing lamination of the first supply film on which the wires, strings, belts, or nets for forming the channel are layered by using the layering roller.

13. The method of producing a vacuum packaging film that has an air channel according to claim 12, wherein the wires, the strings, the belts, or the nets for forming the channel each have a predetermined color.

14. The method of producing a vacuum packaging film according to claim 12, wherein the intervals are regular.

15. A method of producing a vacuum packaging film that has one or more air channels, the method comprising:
longitudinally cutting a sheet to form one or more channels by using a plurality of ring knives that are arranged at intervals from each other;
providing a border sheet while an exhaustion sheet is removed;
layering the border sheet on a side of a supply film;
providing the border sheet and the supply film to a layering roller; and
laminating the border sheet and the supply film by using the layering roller to form a border part of the air channel.

16. The method of claim 15, wherein the ring knives are twin ring knives.

17. The method of claim 15, wherein the layering roller includes a cold roller and a hot roller.

18. The method of claim 15, wherein the ring knives are spaced apart at regular intervals.
